(19) United States
(12) Patent Application Publication
(10) Pub. No.: US 2017/0314708 A1
(43) Pub. Date: Nov. 2, 2017

(54) Conveying Hose

(71) Applicant: CONTITECH SCHLAUCH GMBH, Hannover (DE)

(72) Inventors: Steffen Wietzke, 31311 (DE); Siegfried Reck, Nienburg (DE); Thomas Völxen, Kassel (DE); Jürgen Uhe, Bad Arolsen (DE)

(73) Assignee: CONTITECH SCHLAUCH GMBH, Hannover (DE)

(21) Appl. No.: 15/526,337

(22) PCT Filed: Sep. 21, 2015
(86) PCT No.: PCT/EP2015/071527

§ 371 Date: May 12, 2017

(30) Foreign Application Priority Data
Nov. 13, 2014 (DE) 10 2014 223 170.1

(51) Int. Cl. F16L 11/127; G01N 27/20; E21F 13/04

(52) U.S. Cl. CPC F16L 11/127; E21F 13/047; G01N 27/20

(57) ABSTRACT

The present invention relates to a conveying hose (100) comprising a hose body (10) for holding a conveyed material (11) to be transported and comprising a wear measuring device (13), wherein the wear measuring device (13) comprises a signal unit (17), a first electrode element (14) formed from a first metal material and a second electrode element (15) formed form a second metal material, wherein the first electrode element (14) and/or the second electrode element (15) is embedded in the hose body (10) and each of the electrode elements (14, 15) is connected to the signal unit (17), wherein the electrode elements (14, 15) form a galvanic unit for generating a voltage detectable on the signal unit (17) during simultaneous contacting of the conveyed material (11).

The invention relates to a conveying hose.

In conveying technology, conveying hoses are used to transport material to be conveyed, such as loose stones for example. Conveying hoses of this kind are often used in mines in which they transport, for example, abrasive stones as material to be conveyed. If abrasive stones are transported on a conveyor hose as the material being conveyed, the hose body of the conveyor hose, on which hose body the material being conveyed rests, may become worn on account of the high degree of friction of the abrasive stones on the radially inner surface of the conveying hose or of the hose body of the conveying hose. If the wear progresses to a great extent, by, for example, parts of individual layers of the hose body being worn away to a great extent in such a way that the hose body may tear on account of the resulting reduced thickness of the hose body in these regions since the load of the material being conveyed can no longer be supported by the hose body, this may result in structural failure of the hose body and therefore of the conveying hose. One objective is therefore to be able to establish wear phenomena of this kind as early as possible in order to be able to intervene at an early stage, before it can result in such structural failure of the hose body.

However, to date, wear of the conveying hose has usually been checked only by optical assessment by the operator of the conveying hose system, this being difficult and sometimes impossible to carry out, particularly in the case of locations of the conveying hose which are difficult to access.

The invention is therefore based on the object of providing a conveying hose in which wear of the hose body can be checked in an automated manner, wherein automated checking of wear of the hose body is preferably intended to be possible without an external energy supply.

According to the invention, the object is achieved by a conveying hose as claimed in claim 1. Advantageous developments of the invention are described in the dependent claims.

The conveying hose according to the invention has a hose body for receiving a material which is to be transported, and has a wear-measuring device, wherein the wear-measuring device has a signal unit, a first electrode element which is formed from a first metal material, and a second electrode element which is formed from a second metal material, wherein the first electrode element and/or the second electrode element are/is embedded in the hose body, and the electrode elements are each connected to the signal unit, wherein the electrode elements, when they simultaneously come into contact with the material being conveyed, form a galvanic unit for generating a voltage which can be detected at the signal unit.

The conveying hose according to the invention is therefore distinguished, in particular, in that it now has a wear-measuring device which allows automated measurement of wear of the hose body of the conveyor hose and, when wear is detected, indicates this to an operator of the conveying hose system. In this case, the wear-measuring device is formed in such a way that it can operate without an external energy supply. This is achieved by the wear-measuring device being formed in such a way that it can form a galvanic unit in the form of a galvanic element or a galvanic cell together with the material which is to be transported. The function of a galvanic unit is based on a redox reaction. Reduction and oxidation take place physically separately from one another in a respective half-cell. Connecting the two half-cells to an electron conductor and an ion conductor closes the electrical circuit. The voltage of the electric current can be calculated using the Nernst equation. It depends on the type of metals used, the concentration in the solution of the respective half-cell and also the temperature. In contrast to electrolysis, for example in electroplating technology, electrical energy can be obtained in the galvanic unit, whereas electrolysis consumes electrical energy. The oxidation takes place at the anode and the reduction takes place at the cathode. The galvanic unit supplies a voltage until the electrochemical equilibrium is reached. In the case of the wear-measuring device, the first electrode element, which is formed from a metal material, forms a first half-cell of this kind, and the second electrode element, which is formed from a second metal material, forms a second half-cell of this kind. The material being conveyed itself serves as the ion conductor, said material comprising, together with the abrasive stones, mineral- and salt- containing water or slurry which can establish good conduction of ions between the two half-cells which are formed by the two electrode elements. The signal unit, which is connected to the two electrode elements, serves as the electron conductor. The two electrode elements are formed from two different metal materials, wherein one metal material is more noble than the other metal material. At least one of the two electrode elements is embedded in the hose body, so that at least one of the two electrode elements is covered by the material of the hose body, in particular an outer layer of the hose body, and therefore cannot yet come into contact with the material being conveyed, in the case of a good and therefore intact state of the hose body, that is to say there is still no wear. As soon as excessive abrasion acts on the hose body owing to the abrasive stones and, as a result, the outer layer of the hose body is at least partially destroyed, one or both of the electrode elements which are situated beneath the outer layer are exposed, so that they can come into contact with the material being conveyed. As soon as the two electrode elements simultaneously come into contact with the material being conveyed, the wear-measuring device, together with the material being conveyed, can form a galvanic unit by the mineral- and salt-containing water of the material being conveyed acting as an electrolyte and, as a result, a current being able to flow between the two electrode elements and therefore it being possible to generate a voltage which can be detected at the signal unit. As soon as a voltage is detected at the signal unit, this information can be passed on to the operator of the conveying hose system, so that the operator of the conveying hose system can identify that the hose body has become worn, so that appropriate measures or precautions can be taken. Owing to the formation of a galvanic unit in interaction with the material being conveyed, the wear-measuring device manages without an additional energy supply.

Therefore, a diagnosis, in particular a remote diagnosis, of a degree of wear of the hose body of a conveying hose with an intrinsic chemical energy supply is possible by means of the invention.

In order to be able to measure wear over the entire length of the hose body, it is preferably provided that the electrode elements each extend over the length, in particular the entire length, of the hose body. As a result, wear which occurs can be detected at a large number of points over the length of the hose body, so that the entire hose body can be subject to checking for wear and therefore appropriate precautions can be taken in good time when wear occurs.

However, it is also possible for at least one of the two electrode elements to not extend over the entire length of the hose body, but rather only over a partial length region of the hose body. For example, one of the two electrode elements can be formed from a plurality of individual electrodes which can each project into the material being conveyed in different positions, which are spaced apart from one another, along the length of the hose body at least in regions, so that said individual electrodes can be in permanent contact with the material being conveyed. For example, one of the electrode elements can also be formed from one or more parts of a fitting of the conveying hose, which fitting is in permanent contact with the material being conveyed.

It is preferably further provided that the electrode elements are arranged opposite one another as seen in cross section of the hose body. Owing to the arrangement of the two electrode elements opposite one another as seen in cross section, defined half-cells which extend over the entire cross section of the hose body are formed, it being possible for said half-cells to be bridge-connected to one another by the mineral- and salt-containing medium in the form of water or slurry of the material being conveyed, so that a particularly reliable action of the galvanic unit can be achieved. However, it is also possible for the two electrode elements to be arranged at an angle of <180° in relation to one another, in particular immediately adjacent to one another, as seen in cross section of the hose body.

In order to furthermore also be able to realize as uniform a distribution of the electrode elements and therefore uniform measurement of wear over the circumference of the hose body, it is further preferably provided that the first electrode element and/or the second electrode element are/is embedded in the hose body in a helical manner.

In this case, it is further preferably provided that the first electrode element and the second electrode element are each embedded in the hose body in a helical manner in such a way that they form a double helix shape together. In order to form the double helix shape, the electrode elements are preferably arranged alternately in a helical manner within the hose body. As a result, the wear-measuring points which are formed by the electrode elements are increased over the circumference and the length of the hose body, as a result of which wear measurement can be further improved.

The electrode elements can, for example, each be formed in the shape of a strip or in the shape of a wire, as a result of which they can be introduced into the hose body during the production process of the hose body with a level of expenditure which is reduced as far as possible and can extend over the entire length of the hose body, in order to be able to provide as many wear-measuring points as possible.

The metal materials which are selected for the electrode elements preferably have a sufficiently high electrochemical potential difference in order to be able to reach a sufficiently high voltage and, as a result, are able to initiate current flow when said electrode elements come into contact with ions which are dissolved in the mineral- and salt-containing medium.

In this case, it is preferably provided that the metal material of the first electrode element contains copper, preferably Cu²⁺/Cu, and the metal material of the second electrode element contains magnesium, preferably Mg/Mg²⁺.

As an alternative, it can be provided that the metal material of the first electrode element contains copper, preferably Cu²⁺/Cu, and the metal material of the second electrode element contains aluminum, preferably Al/Al³⁺.

As a further alternative, it can preferably be provided that the metal material of the first electrode element contains copper, preferably Cu²⁺/Cu, and the metal material of the second electrode element contains zinc, preferably Zn/Zn²⁺.

However, further combinations and other kinds of combinations of metal materials for the two electrode elements are also feasible.

In order that the operator of the conveying hose system can identify the occurrence of wear on the hose body as quickly and clearly as possible, it is preferably provided that the signal unit has an output unit which, when a voltage is detected, outputs an acoustic signal and/or a visual signal. The signal serves as a warning signal for the operator. An acoustic signal can be output, for example, in the form of a warning tone by means of a loudspeaker. A visual signal can be output, for example, by means of an indicator apparatus or a warning lamp, for example a light-emitting diode. The output unit can also be arranged physically separate from the other constituent parts of the signal unit, so that the output unit is connected to the signal unit by means of, preferably, a radio connection, so that information relating to outputting a signal can be transmitted to the output unit by means of this radio connection. This is particularly advantageous when the signal unit is arranged in a position which is difficult for the operator to access and the output unit can be arranged in the vicinity of the position of the operator.

If the current flow within the wear-measuring device is too low, it may also be possible for the current flow to be intensified by means of a circuit, for example a transistor, which provides an externally fitted power supply, but which is required only in the event of a signal, for example by a battery, in order to generate a signal in the output unit of the signal unit.

The invention is explained in more detail below with reference to a preferred exemplary embodiment with reference to the accompanying drawings. In the figures:

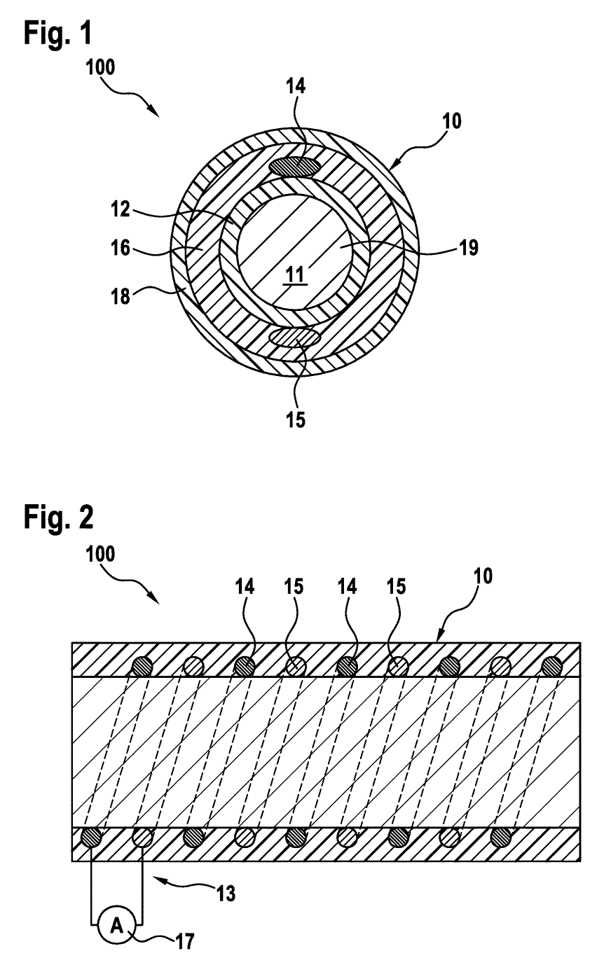

FIG. 1 is a schematic sectional illustration along a transverse direction of a conveying hose according to the invention, wherein the hose body of the conveying hose is in an intact state,

FIG. 2 is a schematic sectional illustration along a longitudinal direction of the conveying hose according to the invention, and

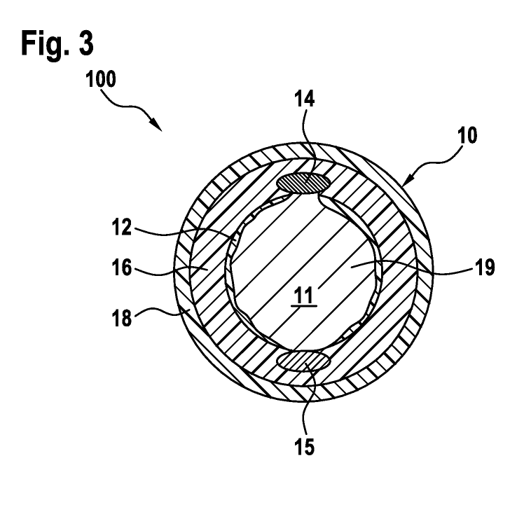

FIG. 3 is a further schematic sectional illustration along the transverse direction of the conveying hose according to the invention with wear phenomena occurring on the hose body of the conveying hose.

FIG. 1 shows a conveying hose 100 sectioned along a transverse direction of the conveying hose 100.

The conveying hose 100 has a hose body 10 which is rolled up to form a tube and is preferably formed from an elastic material, for example a rubber material. The hose body 10 serves to receive the material 11, for example abrasive stones, which is to be transported, wherein said material is arranged in the interior space 19 of the hose body 10, which interior space is formed by the tube shape, and is transported in said interior space. The interior space 19 is completely filled with the material 11 which is to be transported.

The hose body 10 has a plurality of layers, wherein the hose body 10 has at least one radially inner first outer layer 12, one radially outer second outer layer 18 and an inner layer 16 which is arranged between the two outer layers 12, 18. The radially inner first outer layer 12 bounds the interior space 19 and is therefore in direct contact with the material 11 being conveyed which is arranged in the interior space 19.

The conveying hose 100 further has a wear-measuring device 13. FIG. 1 shows a first electrode element 14, which is formed from a first metal material, and a second electrode element 15, which is formed from a second metal material, of the wear-measuring device 13. The two electrode elements 14, 15 are arranged in a manner embedded in the inner layer 16 of the hose body 10, so that the electrode elements 14, 15 are covered by the two outer layers 12, 18 and therefore are not visible when the hose body 10 is in an intact state, as is shown in FIG. 1.

As shown in FIG. 1, the two electrode elements 14, 15 are arranged opposite one another.

FIG. 1 shows the conveying hose in an intact state of this kind, in which no wear has yet occurred on the hose body 10 owing to the material 11 being conveyed, so that the two electrode elements 14, 15 are still completely embedded in the hose body 10 and the outer layer 12 of the hose body 10 is formed between the electrode elements 14, 15 and the material 11 being conveyed, so that contact between the electrode elements 14, 15 and the material 11 being conveyed is prevented. In this state, no current can flow between the two electrode elements 14, 15 either, so that no voltage can be detected either since the salt- and mineral-containing medium within the material 11 being conveyed cannot yet function as an ion conductor or ion bridge between the two electrode elements 14, 15 which each form a half-cell.

FIG. 2 shows a sectional illustration of the hose body 10 along its longitudinal direction and therefore along its length, wherein the section is formed through the inner layer 16 of the hose body 10. Said figure shows that the two electrode elements 14, 15 are arranged in an alternating manner, in particular in a helically alternating manner, in relation to one another, so that they form a double helix shape. The two electrode elements 14, 15 are connected to a signal unit 17 of the wear-measuring device 13, wherein this signal unit 17 forms a kind of ammeter or voltmeter. As soon as the electrode elements 14, 15 come into contact with the material 11 being conveyed and, as a result, a galvanic unit is formed, a voltage which is produced by the resulting current flow between the two electrode elements 14, 15 which occurs can be detected at the signal unit 17. As soon as a voltage has been detected at the signal unit 17, a signal, in particular a warning signal, in the form of an acoustic signal or a visual signal can be output by means of the signal unit 17, in particular by means of an output unit of the signal unit 17, in order to indicate to the operator of the conveying hose system that wear has occurred on the hose body 10 of the conveying hose 100 and appropriate measures should be taken.

As shown with reference to FIG. 2, the electrode elements 14, 15 preferably extend over the entire length of the hose body 10 and preferably also over the entire circumference of the hose body 10 in this case. The electrode elements 14, 15 can each be formed in the shape of a strip or in the shape of a wire.

The metal material of the first electrode element 14 can contain, for example, copper, preferably Cu²⁺/Cu. The metal material of the second electrode element 15 can contain, for example, magnesium, preferably Mg/Mg²⁺, or aluminum, preferably Al/Al³⁺, or zinc, preferably Zn/Zn²⁺.

FIG. 3 shows the conveying hose 100 in a state in which a large amount of wear has occurred in such a way that, on account of an abrasive action of the material 11 being conveyed, the outer layer 12 of the hose body 10 has been severely worn away at least in regions in such a way that the electrode elements 14, 15 are exposed at least in regions and therefore come into contact with the material 11 being conveyed and, in particular, the salt- and mineral-containing medium of the material 11 being conveyed. As a result, a redox reaction can start at the electrode element 14, 15 which has the more noble metal material, wherein an electrical circuit through which current can flow and, as a result, a voltage can be detected at the signal unit 17 is closed by means of the two half-cells which are formed by the electrode elements 14, 15 and contain the salt- and mineral-containing medium, which functions as the ion conductor, of the material 11 being conveyed, and the signal unit 17 which is connected to the two electrode elements 14, 15, as a result of which a signal, in particular a warning signal, can be output at the output unit of the signal unit 17 in order to be able to indicate to a user of the conveying hose system that wear has occurred on the hose body 10.

### LIST OF REFERENCE SIGNS

### Part of the Description

100 Conveying hose
10 Hose body
11 Material being conveyed
12 First outer layer
13 Wear-measuring device
14 First electrode element
15 Second electrode element
16 Inner layer
17 Signal unit
18 Second outer layer
19 Interior space

1.-10. (canceled)

11. A conveying hose comprising a hose body for receiving a material which is to be transported, the hose body comprising a wear-measuring device;
wherein the wear-measuring device comprises a signal unit, a first electrode element which is formed from a first metal material, and a second electrode element which is formed from a second metal material;
wherein at least the first electrode element is embedded in the hose body, and wherein the first electrode element and the second electrode element are each connected to the signal unit;
wherein the first electrode element and the second electrode element are, when they simultaneously come into contact with the material being conveyed, form a galvanic unit for generating a voltage which can be detected at the signal unit; and,
wherein the first metal material of the first electrode element comprises copper, and the second metal material of the second electrode element comprises magnesium.

12. The conveying hose as claimed in claim 11, wherein the second electrode element is embedded in the hose body.

13. The conveying hose as claimed in claim 11, wherein the first electrode element and the second electrode element extend over the length of the hose body.

14. The conveying hose as claimed in claim 11, wherein the first electrode element and the second electrode element are arranged opposite one another as seen in cross section of the hose body.

15. The conveying hose as claimed in claim 11, wherein at least one of the first electrode element or the second electrode element are embedded in the hose body in a helical manner.

16. The conveying hose as claimed in claim 15, wherein the first electrode element and the second electrode element are embedded in the hose body in a helical manner.

17. The conveying hose as claimed in claim 16, wherein the first electrode element and the second electrode element are each embedded in the main body in a helical manner in such a way that they form a double helix shape together.

18. The conveying hose as claimed in claim 11, wherein the signal unit comprises an output unit which, when a voltage is detected, outputs one or more of an acoustic signal and a visual signal.

19. A conveying hose comprising a hose body for receiving a material which is to be transported, the hose body comprising a wear-measuring device;
wherein the wear-measuring device comprises a signal unit, a first electrode element which is formed from a first metal material, and a second electrode element which is formed from a second metal material;
wherein at least the first electrode element is embedded in the hose body, and wherein the first electrode element and the second electrode element are each connected to the signal unit;
wherein the first electrode element and the second electrode element are, when they simultaneously come into contact with the material being conveyed, form a galvanic unit for generating a voltage which can be detected at the signal unit; and,
wherein the first metal material of the first electrode element comprises copper, and the second metal material of the second electrode element comprises aluminum.

20. The conveying hose as claimed in claim 19, wherein the second electrode element is embedded in the hose body.

21. The conveying hose as claimed in claim 19, wherein the first electrode element and the second electrode element extend over the length of the hose body.

22. The conveying hose as claimed in claim 19, wherein the first electrode element and the second electrode element are arranged opposite one another as seen in cross section of the hose body.

23. The conveying hose as claimed in claim 19, wherein at least one of the first electrode element or the second electrode element are embedded in the hose body in a helical manner

24. The conveying hose as claimed in claim 23, wherein the first electrode element and the second electrode element are embedded in the hose body in a helical manner.

25. The conveying hose as claimed in claim 24, wherein the first electrode element and the second electrode element are each embedded in the main body in a helical manner in such a way that they form a double helix shape together.

26. The conveying hose as claimed in claim 19, wherein the signal unit comprises an output unit which, when a voltage is detected, outputs one or more of an acoustic signal and a visual signal.

27. A conveying hose comprising a hose body for receiving a material which is to be transported, the hose body comprising a wear-measuring device;
wherein the wear-measuring device comprises a signal unit, a first electrode element which is formed from a first metal material, and a second electrode element which is formed from a second metal material;
wherein at least the first electrode element is embedded in the hose body, and wherein the first electrode element and the second electrode element are each connected to the signal unit;
wherein the first electrode element and the second electrode element are, when they simultaneously come into contact with the material being conveyed, form a galvanic unit for generating a voltage which can be detected at the signal unit; and,
wherein the first metal material of the first electrode element comprises copper, and the second metal material of the second electrode element comprises zinc.

28. The conveying hose as claimed in claim 27, wherein the second electrode element is embedded in the hose body.

29. The conveying hose as claimed in claim 27, wherein the first electrode element and the second electrode element extend over the length of the hose body.

30. The conveying hose as claimed in claim 27, wherein the first electrode element and the second electrode element are arranged opposite one another as seen in cross section of the hose body.

31. The conveying hose as claimed in claim 27, wherein at least one of the first electrode element or the second electrode element are embedded in the hose body in a helical manner.

32. The conveying hose as claimed in claim 31, wherein the first electrode element and the second electrode element are embedded in the hose body in a helical manner.

33. The conveying hose as claimed in claim 32, wherein the first electrode element and the second electrode element are each embedded in the main body in a helical manner in such a way that they form a double helix shape together.

34. The conveying hose as claimed in claim 27, wherein the signal unit comprises an output unit which, when a voltage is detected, outputs one or more of an acoustic signal and a visual signal.
